(19) United States
(12) Patent Application Publication
(10) Pub. No.: US 2011/0007392 A1
(43) Pub. Date: Jan. 13, 2011

(54) LIGHT COMBINER

(76) Inventors: Ronald E. English, JR., Cincinnati, OH (US); Simon Magarill, Cincinnati, OH (US); Charles L. Bruzzone, Woodbury, MN (US); David M. Snively, Cincinnati, OH (US); Andrew J. Ouderkirk, Singapore (SG)

Correspondence Address: 3M INNOVATIVE PROPERTIES COMPANY, PO BOX 33427, ST. PAUL, MN, 55133-3427, US

(21) Appl. No.: 12/810,373

(22) PCT Filed: Dec. 17, 2008
(86) PCT No.: PCT/US2008/087222

§ 371 Date: Sep. 22, 2010

Related U.S. Application Data
(60) Provisional application No. 61/017,190, filed on Dec. 28, 2007.
(60) Provisional application No. 61/095,129, filed on Sep. 8, 2008.

(51) Int. Cl. G02B 27/28

(52) U.S. Cl. 359/495

(57) ABSTRACT

Light combiners and light splitters, and methods of using light combiners and light splitters are described. In particular, the description relates to light combiners and splitters that combine and split, respectively, light of different wavelength spectrums using polarizing beam splitters. The polarizing beam splitters include a reflective polarizer to efficiently split incident light into transmitted and reflected beams having different polarization directions. Reflectors and quarter-wave retarders are positioned facing selected prism faces of the polarizing beam splitters, to affect the polarization state of light passing through the prism faces. The reflectors can be dichroic filters adapted to reflect light that is outside a selected wavelength range, so that light of different wavelength spectrums can be affected at different prism faces. The surfaces of each polarizing beam splitter can be polished so that the light utilization efficiency is increased due to total internal reflection within the polarizing beam splitter. The light combiners can combine up to five unpolarized different color lights to produce an unpolarized polychromatic light output, which may be white light useful for a projection display. The light splitters can split unpolarized polychromatic light to produce up to five unpolarized different color light outputs.

### FIELD OF TECHNOLOGY

This description generally relates to light combiners and light splitters, and methods of using light combiners and light splitters. In particular, the description relates to light combiners and splitters that combine and split, respectively, light of different wavelength spectrums using polarizing beam splitters.

### BACKGROUND

Projection systems used for projecting an image on a screen can use multiple wavelength spectrum light sources, such as light emitting diodes (LEDs), with different wavelength spectrums to generate the illumination light. Several optical elements are disposed between the LEDs and the image display unit to combine and transfer the light from the LEDs to the image display unit. The image display unit can use various methods to impose an image on the light. For example, the image display unit may use polarization, as with transmissive or reflective liquid crystal displays (LCDs).

Still other projection systems used for projecting an image on a screen can use white light configured to imagewise reflect from a digital micro-mirror array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

### SUMMARY

Image brightness is an important parameter of a projection system. The brightness of color light sources and the efficiencies of collecting, combining, homogenizing and delivering the light to the image display unit all effect brightness. As the size of modern projector systems decreases, there is a need to maintain an adequate level of output brightness while at the same time keeping heat produced by the light sources at a low level that can be dissipated in a small projector system. There is a need for a light combining system that combines multiple color lights with increased efficiency to provide a light output with an adequate level of brightness without excessive power consumption by light sources.

Generally, the present description relates to light combiners comprising polarizing beam splitters, and methods of using light combiners. The present description also relates to light splitters comprising polarizing beams splitters, and methods of using light splitters.

In one aspect, a light combiner includes a polarizing beam splitter that includes two prisms having four prism faces and two ends, and a reflective polarizer that is disposed between the diagonal faces of the two prisms. The prism faces and ends can be polished so that total internal reflection can occur within the prism. The reflective polarizer can be a Cartesian reflective polarizer aligned to a first polarization direction. The reflective polarizer can be a polymeric multilayer optical film. The light combiner includes quarter-wave retarders disposed facing three of the four external prism faces. The quarter-wave retarders can be aligned to the first polarization direction. A reflector is disposed facing each of the quarter-wave retarders.

In another aspect, a light combiner used for combining two lights having different wavelength spectrums includes two reflectors that are dichroic filters that transmit a first and second wavelength of light respectively, and reflect other wavelengths of light. The light combiner includes a third reflector that is a mirror. In a further aspect, a light combiner used for combining three lights having different wavelength spectrums includes three reflectors that are dichroic filters that transmit a first, second and third wavelength of light, respectively, and reflect other wavelengths of light. In some embodiments, at least some of the prisms, reflective polarizer, quarter-wave retarders, reflectors and dichroic filters are bonded together with an optical adhesive.

In yet a further aspect, a method of combining light of two or three wavelength spectrums includes providing a light combiner having a polarizing beam splitter including a first, second and third dichroic filter that transmits light having a first, second and third wavelength spectrum, respectively and reflect other wavelengths of light, facing three of the four prism faces; directing light having the first, second and third wavelength spectrum toward the dichroic filters; and receiving combined light from the fourth prism face. The first and second lights can be unpolarized, and the combined light can also be unpolarized.

In another aspect, a method of splitting polychromatic light includes providing a light combiner including first, second and third dichroic filters that transmit light having a first, second and third wavelength spectrum, facing three of the four prism faces, directing polychromatic combined light toward the fourth prism face, and receiving light having the first, second and third wavelength spectrum from the first, second and third dichroic filters. The polychromatic light can be unpolarized, and the received lights can also be unpolarized. In some embodiments, the third dichroic filter is replaced by a mirror, and first and second wavelength spectrum light is received from the remaining two dichroic filters.

In one aspect, a light combiner includes two polarizing beam splitters that each includes two prisms having four prism faces and two ends, and a reflective polarizer disposed between the diagonal faces of each of the two prisms. The two polarizing beam splitters are positioned so that two of the prism faces are facing each other. The prism faces and ends can be polished so that total internal reflection can occur within each polarizing beam splitter. The reflective polarizers can be Cartesian reflective polarizers aligned to a first polarization direction. The reflective polarizers can be polymeric multilayer optical films. The light combiner includes quarter-wave retarders disposed facing five of the six external prism faces. The quarter-wave retarders are aligned to the first polarization direction. A reflector is disposed facing each of the quarter-wave retarders.

In still a further aspect, a light combiner used for combining two lights having different wavelength spectrums includes two reflectors that are dichroic filters that transmit a first and second wavelength of light respectively and reflect other wavelengths of light; and third, fourth and fifth reflectors that are mirrors.

In another aspect, a light combiner used for combining three lights having different wavelength spectrums includes three reflectors that are dichroic filters that transmit a first, second and third wavelength of light respectively, and reflect other wavelengths of light; and fourth and fifth reflectors that are mirrors.

In a further aspect, a light combiner used for combining four lights having different wavelength spectrums includes four reflectors that are dichroic filters that transmit a first, second, third and fourth wavelength of light respectively, and reflect other wavelengths of light; and a fifth reflector that is a mirror.

In yet another aspect, a light combiner used for combining five lights having different wavelength spectrums includes five reflectors that are dichroic filters that transmit a first, second, third, fourth and fifth wavelength of light respectively, and reflect other wavelengths of light.

In one aspect, a sixth dichroic filter and an additional quarter-wave retarder are disposed between the two prisms to improve the performance of the light combiner. In some embodiments, at least some of the prisms, reflective polarizer, quarter-wave retarders, reflectors and dichroic filters are bonded together with an optical adhesive.

In another aspect, a method of combining light of from two to five wavelength spectrums includes providing a light combiner having two polarizing beam splitters, disposing a first through fifth dichroic filter that transmit light having a first through fifth wavelength spectrum respectively, and reflect other wavelengths of light, on five of the six external prism faces; directing light having the first through fifth wavelength spectrum toward the dichroic filters; and receiving combined light from the sixth external prism face. The first through fifth lights can be unpolarized, and the combined light can also be unpolarized.

In a further aspect, a method of splitting polychromatic light includes the steps of providing a light combiner including first through fifth dichroic filters that transmit light having a first through fifth wavelength spectrum respectively, and reflect other wavelengths of light, on five of the six external prism faces; directing polychromatic light toward the sixth prism face; and receiving light having the first through fifth wavelength spectrum from the first through fifth dichroic filters. The polychromatic light can be unpolarized, and the received lights can also be unpolarized. Up to three dichroic filters can be replaced by mirrors, and light can be received from the remaining two dichroic filters.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter.

FIG. 2 is a perspective view of a polarizing beams splitter with quarter-wave retarders.

FIGS. 3A-3D are top schematic views of a light combiner.

FIG. 4 is a top schematic view showing a polarizing beam splitter.

FIG. 5 is a top schematic view of a light splitter.

FIGS. 6A-6B are top schematic views of a light combiner.

FIGS. 7A-7B are top schematic views of a light combiner.

FIG. 8 is a top schematic view of a light splitter.

FIGS. 9A-9C are top schematic views of a light combiner.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The light combiners described herein receive different wavelength spectrum lights and produce a combined light output that includes the different wavelength spectrum lights. In some embodiments, the combined light has the same etendue as each of the received lights. The combined light can be a polychromatic combined light that comprises more than one wavelength spectrum of light. In one aspect, each of the different wavelength spectrums of light correspond to a different color light (e.g. red, green and blue), and the combined light output is white light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

Also for the purposes of the description provided herein, the term “facing” refers to one element disposed so that a perpendicular line from the surface of the element follows an optical path that is also perpendicular to the other element. One element facing another element can include the elements disposed adjacent each other. One element facing another element further includes the elements separated by optics so that a light ray perpendicular to one element is also perpendicular to the other element.

When, two or more unpolarized color lights are directed to the color combiner, each are split according to polarization by a reflective polarizer in a polarizing beam splitter (PBS). The light can be collimated, convergent, or divergent when it enters the PBS. Convergent or divergent light entering the PBS can be lost through one of the faces or ends of the PBS. To avoid such losses, all of the exterior faces of the PBS can be polished to enable total internal reflection (TIR) within the PBS. Enabling TIR improves the utilization of light entering the PBS, so that substantially all of the light entering the PBS within a range of angles is redirected to exit the PBS through the desired face.

At least one polarization component of each color light entering the light combiner passes through to a polarization rotating reflector. The polarization rotating reflector reverses the propagation direction of the light and alters the magnitude of the polarization components, depending of the components and their orientation in the polarization rotating reflector. The polarization rotating reflector includes a reflector and a retarder. In one embodiment, the reflector can be a mirror that reflects the transmission of light by reflection. In one embodiment, the reflector can be a dichroic filter that transmits one wavelength spectrum of light and reflects other wavelengths of light. The dichroic filter can reflect other wavelengths of light by reflecting the light. The retarder can provide any desired retardation, such as an eighth-wave retarder, a quarter-wave retarder, and the like. In embodiments described herein, there can be an advantage to using a quarter-wave retarder and an associated reflector. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the color combiner result in efficient combined light output from the light combiner. In contrast, linearly polarized light is changed to a polarization state partway between s-polarization and p-polarization (either elliptical or linear) as it passes through other retarders and orientations, and can result in a lower efficiency of the combiner.

According to one aspect, a light combiner comprises two PBSs with associated quarter-wave retarders and reflectors arranged in cascade, to produce combined light. Light from up to five different sources can be directed into five of the six exterior prism faces of the two cascaded PBSs, and combined light is received from the sixth exterior prism face.

The components of a light combiner including prisms, reflective polarizers, quarter-wave retarders, mirrors and dichroic filters can be bonded together by a suitable optical adhesive. The optical adhesive used to bond the components together can have a lower index of refraction than the index of refraction of the prisms used in the light combiner. A light combiner that is fully bonded together offers advantages including alignment stability during assembly, handling and use.

The embodiments described above can be more readily understood by reference to the Figures and their accompanying description, which follows.

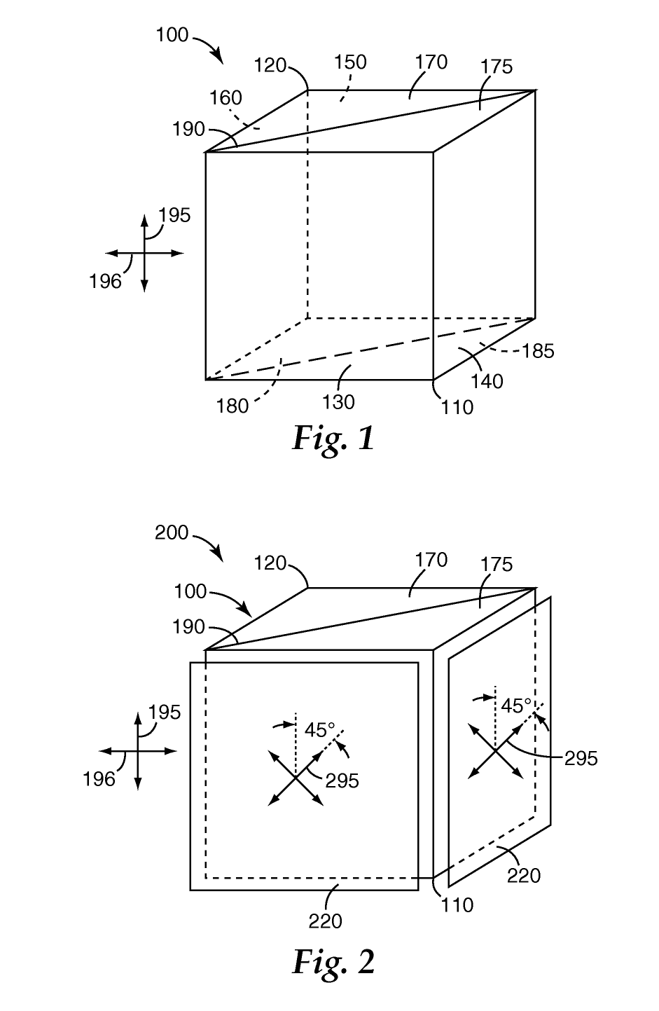

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves to clarify the description of PBS 100 in the discussion that follows. Reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis direction, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization direction 195, and perpendicular to a second polarization direction 196. In one embodiment, the first polarization direction 195 can be the s-polarization direction, and the second polarization direction 196 can be the p-polarization direction. As shown in FIG. 1, the first polarization direction 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

FIG. 2 is a perspective view of the alignment of quarter-wave retarders to a PBS, as used in some embodiments. Quarter-wave retarders can be used to change the polarization state of incident light. PBS retarder system 200 includes PBS 100 having first and second prisms 110 and 120. A quarter-wave retarder 220 is disposed facing each of the first and second prism faces, 130 and 140. Reflective polarizer 190 is a Cartesian reflective polarizer film aligned to first polarization direction 195. Quarter-wave retarders 220 include a quarter-wave polarization direction 295 aligned at 45° to first polarization direction 195. Although FIG. 2 shows polarization direction 295 aligned at 45° to first polarization direction 195 in a clockwise direction, polarization direction 295 can instead be aligned at 45° to first polarization direction 195 in a counterclockwise direction. In some embodiments, quarter-wave polarization direction 295 can be aligned at any degree orientation to first polarization direction 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization direction. Other orientations of quarter-wave retarders can result in s-polarized light not being fully transformed to p-polarized light, and p-polarized light not being fully transformed to s-polarized light, upon reflection from the mirrors, resulting in reduced efficiency of the light combiners described elsewhere in this description.

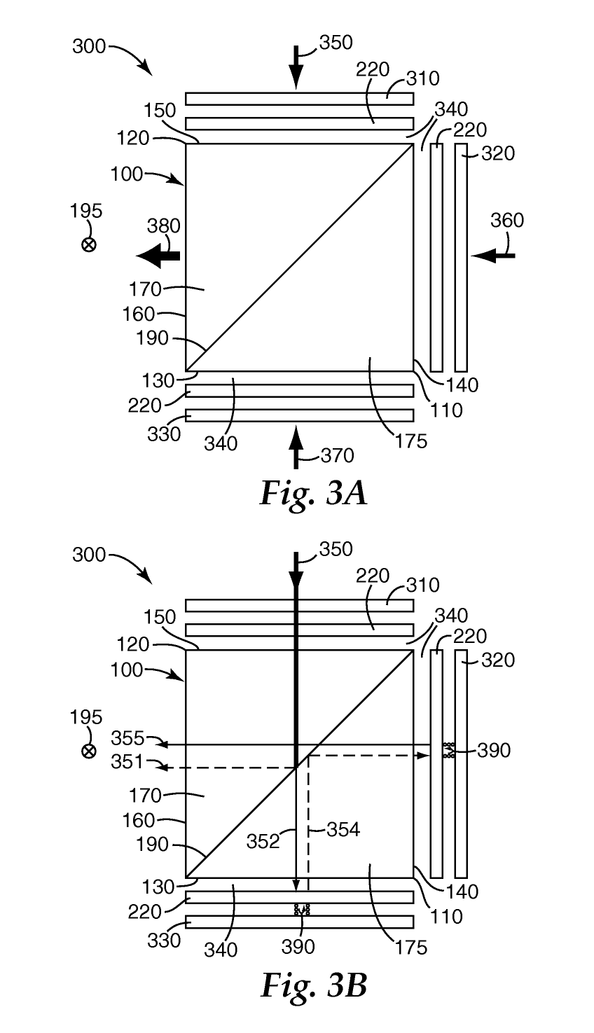

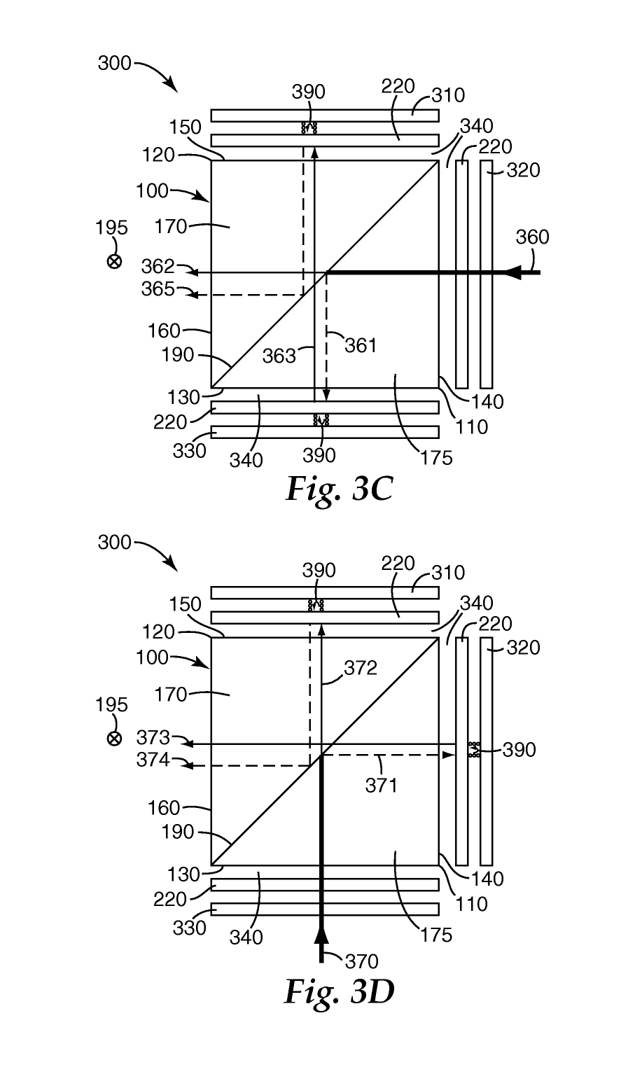

FIG. 3A is a top view of a light combiner. In FIG. 3A, a light combiner 300 includes PBS 100 having reflective polarizer 190 disposed between the diagonal faces of prisms 110 and 120. Prism 110 includes first and second prism faces 130, 140 having a 90° angle between them. Prism 120 includes third and fourth prism face 150, 160 having a 90° angle between them. Reflective polarizer 190 can be a Cartesian reflective polarizer aligned to the first polarization direction 195 (in this view, perpendicular to the page). Reflective polarizer 190 can instead be a non-Cartesian polarizer.

Light combiner 300 includes quarter-wave retarders 220 disposed facing the first, second and third prism faces 130, 140, 150. Quarter-wave retarders 220 are aligned at a 45° angle to the first polarization direction 195. An optically transmissive material 340 is disposed between each quarter-wave retarder 220 and their respective prism faces. The optically transmissive material 340 can be any material that has an index of refraction lower than the index of refraction of prisms 110, 120. In one embodiment, the optically transmissive material 340 is air. In another embodiment, the optically transmissive material 340 is an optical adhesive which bonds quarter-wave retarders 220 to their respective prism faces.

Light combiner 300 includes a first, second and third reflector 310, 320, 330 disposed facing quarter-wave retarders 220 as shown. Each of the reflectors 310, 320, 330 can be separate from the adjacent quarter-wave retarder 220 as shown in FIG. 3A. Further, each of the reflectors 310, 320, 330 can be in direct contact with the adjacent quarter-wave retarder 220. Alternatively, each of the reflectors 310, 320, 330 can be adhered to the adjacent quarter-wave retarder 220 with an optical adhesive. The optical adhesive can be a curable adhesive. The optical adhesive can also be a pressure-sensitive adhesive.

Light combiner 300 can be a two color combiner. In this embodiment, two of the reflectors 310, 320, 330 are a first and a second dichroic filter selected to transmit a first and a second color light respectively, and reflect other colors of light. The third reflector is a mirror. By mirror is meant a specular reflector selected to reflect substantially all colors of light. The first and second color light can have minimum overlap in the spectral range, however there can be substantial overlap if desired.

In one embodiment shown in FIG. 3A, light combiner 300 is a three color combiner. In this embodiment, reflectors 310, 320, 330 are first, second and a third dichroic filter selected to transmit the first, second, and a third color light respectively, and reflect other colors of light. In one aspect, the first, second and third color light have minimum overlap in the spectral range, however there can be substantial overlap, if desired. A method of using light combiner 300 of this embodiment includes directing a first light 350 having the first color toward first dichroic filter 310, directing a second light 360 having the second color toward second dichroic filter 320, directing a third light 370 having the third color toward third dichroic filter 330, and receiving combined light 380 from the fourth face of PBS 100. The path of each of the first, second and third light 350, 360, 370 are further described with reference to FIGS. 3B-3D.

In one embodiment, each of the first, second and third light 350, 360, 370 can be unpolarized light and the combined light 380 is unpolarized. In a further embodiment, each of the first, second and third lights 350, 360, 370 can be red, green and blue unpolarized light, and the combined light 380 can be unpolarized white light. Each of the first, second, and third lights 350, 360, 370 can comprise light from a light emitting diode (LED) source. Various light sources can be used such as lasers, laser diodes, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

Turning now to FIG. 3B, the optical path of first light 350 through light combiner 300 is described for the embodiment where first light 350 is unpolarized. In this embodiment, unpolarized light comprising light ray 351 having the second polarization direction, and light ray 355 having the first polarization direction, exit PBS 100 through fourth prism face 160.

First light 350 is directed through first dichroic filter 310, quarter-wave retarder 220, and enters PBS 100 through third prism face 150. First light 350 intercepts reflective polarizer 190 and is split into light ray 352 having the first polarization direction and light ray 351 having the second polarization direction. Light ray 351 having the second polarization direction is reflected from reflective polarizer 190 and exits PBS 100 through fourth prism face 160.

Light ray 352 having the first polarization direction passes through reflective polarizer 190, exits PBS 100 through first prism face 130, and changes to circularly polarized light 390 as it passes through quarter-wave retarder 220. Circularly polarized light 390 reflects from third dichroic filter, changing the direction of circular polarization, and passes again through quarter-wave retarder 220, entering PBS 100 through first prism face 130 as light ray 354 having the second polarization direction. Light ray 354 reflects from reflective polarizer 190, exits PBS 100 through second prism face 140, and changes to circularly polarized light 390 as it passes through quarter-wave retarder 220. Circularly polarized light 390 reflects from second dichroic filter 320, changing the direction of circular polarization, and passes again through quarter-wave retarder 220, entering PBS 100 through second prism face 140 as light ray 355 having the first polarization direction. Light ray 355 having the first polarization direction passes through reflective polarizer 190 and exits PBS 100 through fourth prism face 160.

Turning now to FIG. 3C, the optical path of second light 360 through light combiner 300 is described for the embodiment where second light 360 is unpolarized. In this embodiment, unpolarized light comprising light ray 365 having the second polarization direction, and light ray 362 having the first polarization direction, exit PBS 100 through fourth prism face 160.

Second light 360 is directed through second dichroic filter 320, quarter-wave retarder 220, and enters PBS 100 through second prism face 140. Second light 360 intercepts reflective polarizer 190 and is split into light ray 362 having the first polarization direction and light ray 361 having the second polarization direction. Light ray 362 having the first polarization direction passes through reflective polarizer 190 and exits PBS 100 through fourth prism face 160.

Light ray 361 having the second polarization direction, is reflected from reflective polarizer 190, exits the first prism face 130 of PBS 100, and changes to circularly polarized light 390 as it passes through quarter-wave retarder 220. Circularly polarized light 390 reflects from third dichroic filter 330, changing the direction of circular polarization, and passes again through quarter-wave retarder 220, entering PBS 100 through first prism face 130 as light ray 363 having the first polarization direction. Light ray 363 passes through reflective polarizer 190, exits PBS 100 through third prism face 150, and changes to circularly polarized light 390 as it passes through quarter-wave retarder 220. Circularly polarized light 390 reflects from first dichroic filter 310, changing the direction of circular polarization, and passes again through quarter-wave retarder 220, entering PBS 100 through third prism face 150 as light ray 365 having the second polarization direction. Light ray 365 having the second polarization state, reflects from reflective polarizer 190 and exits PBS 100 through fourth prism face 160.

Turning now to FIG. 3D, the optical path of third light 370 through light combiner 300 is described for the embodiment where third light 370 is unpolarized. In this embodiment, unpolarized light comprising light ray 375 having the second polarization direction, and light ray 373 having the first polarization direction, exits PBS 100 through fourth prism face 160.

Third light 370 is directed through third dichroic filter 330, quarter-wave retarder 220, and enters PBS 100 through first prism face 130. Third light 370 intercepts reflective polarizer 190 and is split into light ray 372 having the first polarization direction and light ray 371 having the second polarization direction. Light ray 372 having the first polarization direction passes through reflective polarizer 190, exits the third prism face 150, and changes to circularly polarized light 390 as it passes through quarter-wave retarder 220. Circularly polarized light 390 reflects from first dichroic filter 310, changing the direction of circular polarization, and passes again through quarter-wave retarder 220, entering PBS 100 through third prism face 150 as light ray 374 having the second polarization state. Light ray 374 having the second polarization direction reflects from reflective polarizer 190 and exits PBS 100 through fourth prism face 160.

Light ray 371 having the second polarization direction, reflects from reflective polarizer 190, exits PBS 100 through the second prism face 140 and changes to circularly polarized light 390 as it passes through quarter-wave retarder 220. Circularly polarized light 390 reflects from second dichroic filter 320, changing the direction of circular polarization, passes again through quarter-wave retarder 220 and enters PBS 100 through second prism face 140 as light ray 373 having the second polarization direction. Light ray 373 having the first polarization direction, passes through reflective polarizer 190 and exits PBS 100 through fourth prism face 160.

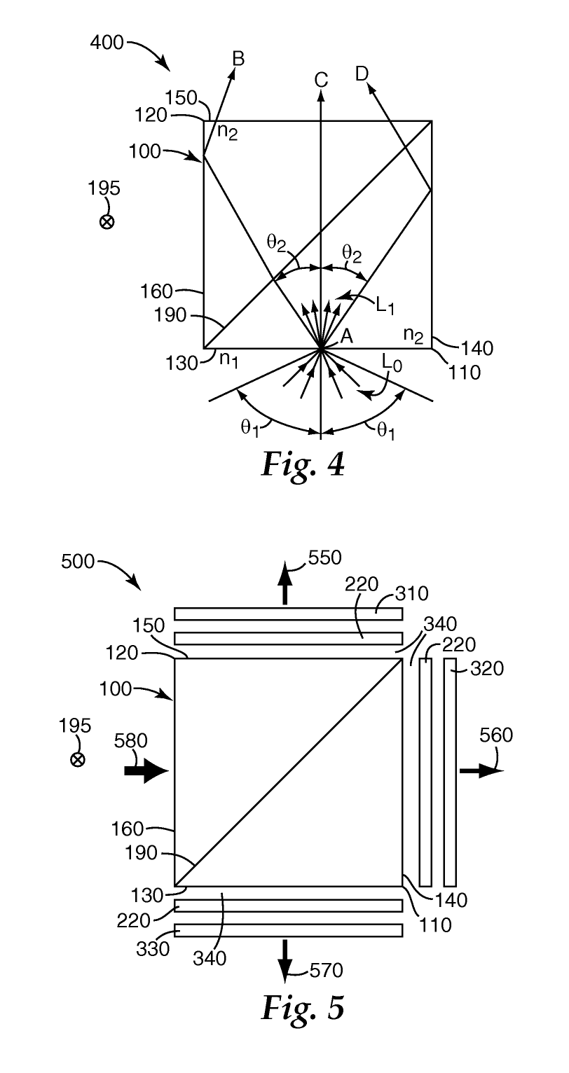

FIG. 4 shows a path of light rays within a polished PBS 400. According to one embodiment, the first, second, third and fourth prism faces 130, 140, 150, 160 of prisms 110 and 120 are polished external surfaces that are in contact with a material having an index of refraction “n₁” that is less than the index of refraction “n₂” of prisms 110 and 120. According to another embodiment, all of the external faces of the PBS 400 (including end faces, not shown) are polished faces that provide TIR of oblique light rays within PBS 400. The polished external surfaces are in contact with a material having an index of refraction “n₁” that is less than the index of refraction “n₂” of prisms 110 and 120. TIR improves light utilization in PBS 400, particularly when the light directed into PBS is not collimated along a central axis, i.e. the incoming light is either convergent or divergent. At least some light is trapped in PBS 400 by total internal reflections until it leaves through third prism face 150. In some cases, substantially all of the light is trapped in PBS 400 by total internal reflections until it leaves through third prism face 150.

As shown in FIG. 4, light rays L₀ enter first prism face 130 within a range of angles θ₁. Light rays L₁ within PBS 400 propagate within a range of angles θ₂ such that Snell's law is satisfied at prism faces 140, 160 and the end faces (not shown). Light rays “AB”, “AC” and “AD” represent three of the many paths of light through PBS 400, that intersect reflective polarizer 190 at different angles of incidence before exiting through third prism face 150. Light rays “AB” and “AD” also both undergo TIR at prism faces 140 and 160, respectively, before exiting. It is to be understood that ranges of angles θ₁ and θ₂ can be a cone of angles so that reflections can also occur at the end faces of PBS 400. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at high angles of incidence. Efficient splitting of polarized light using a MacNeille polarizer can be limited to incidence angles below about 6 or 7 degrees from the normal, since significant reflection of both polarization states occur at larger angles. Efficient splitting of polarized light using a wire-grid polarizer typically requires an air gap adjacent one side of the wires, and efficiency drops when a wire-grid polarizer is immersed in a higher index medium.

FIG. 5 is a top view schematic representation of a light splitter 500 according to one aspect of the invention. Light splitter 500 uses the same components as the light combiner shown in FIGS. 3A-3D, but functions in reverse, i.e. combined light 580 is directed toward fourth prism face 160, and split into a first, second and third received light 550, 560, 570 having first, second and third color, respectively. In FIG. 5, light splitter 500 includes PBS 100 having reflective polarizer 190 disposed between the diagonal faces of prisms 110, 120. Prism 110 includes first and second prism faces 130, 140 having a 90° angle between them. Prism 120 includes third and fourth prism faces 150, 160 having a 90° angle between them. Reflective polarizer 190 can be a Cartesian reflective polarizer aligned to the first polarization direction 195 (in this view, perpendicular to the page), or a non-Cartesian polarizer, but a Cartesian reflective polarizer is preferred.

Light splitter 500 also includes quarter-wave retarders 220 disposed facing the first, second and third prism faces 130, 140, 150. The quarter-wave retarders 220 are aligned at a 45° angle to the first polarization direction 195, as described elsewhere. An optically transmissive material 340 is disposed between each of the quarter-wave retarders 220 and their respective prism faces. Optically transmissive material 340 can be any material that has an index of refraction lower than the index of refraction of prisms 110,120. In one aspect, optically transmissive material 340 can be air. In one aspect, the optically transmissive material 340 can be an optical adhesive which bonds quarter-wave retarders 220 to their respective prism faces.

Light splitter 500 includes first, second and third reflector 310, 320, 330 disposed facing quarter-wave retarders 220 as shown. In one aspect, reflectors 310, 320, 330 can be separated from the adjacent quarter-wave retarder 220 as shown in FIG. 3A. In one aspect, reflectors 310, 320, 330 can be in direct contact with the adjacent quarter-wave retarder 220. In one aspect, reflectors 310, 320, 330 can be adhered to the adjacent quarter-wave retarder 220 with an optical adhesive.

In one embodiment, light splitter 500 is a two color splitter. In this embodiment, two of the reflectors 310, 320, 330 are first and second dichroic filter selected to transmit first and second color light, respectively, and reflect other colors of light. The third reflector is a mirror. By mirror is meant a specular reflector selected to reflect substantially all colors of light. In one aspect, the first and second color light have minimum overlap in the spectral range, however there can be substantial overlap, if desired.

In one embodiment, light splitter 500 is a three color splitter. In this embodiment, reflectors 310, 320, 330 are first, second and third dichroic filter selected to transmit first, second, and third color lights, respectively, and reflect other colors of light. In one aspect, first, second and third color lights have minimum overlap in the spectral range, however there can be substantial overlap, if desired. A method of using light splitter 500 of this embodiment includes the steps of directing combined light 580 toward fourth prism face 160 of PBS 100, receiving first light 550 having the first color from dichroic filter 310, receiving second light 560 having the second color from second dichroic filter 320, and receiving third light 570 having the third color from third dichroic filter 330. The optical path of each of the combined, first, second and third received lights 580, 550, 560, 570 follow the description in FIGS. 3B-3D, however, the direction of all of the light rays is reversed.

In one embodiment, combined light 580 can be unpolarized light, and each of the first, second and third lights 550, 560, 570 are unpolarized lights. In one embodiment, combined light 580 can be unpolarized white light, and each of the first, second and third lights 550, 560, 570 are red, green and blue unpolarized lights. According to one aspect, combined light 580 comprises light from a light emitting diode (LED) source. Various light sources can be used such as lasers, laser diodes, organic LED's (OLED's), and non solid state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

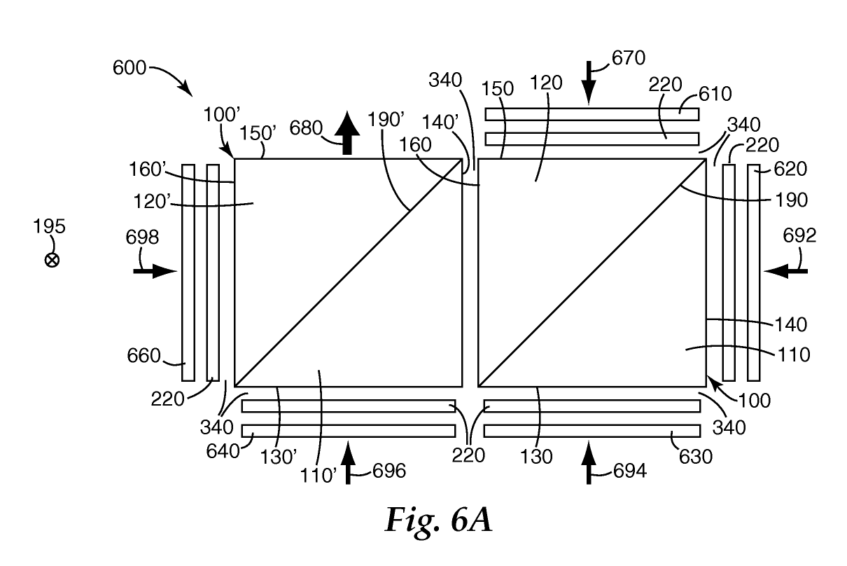

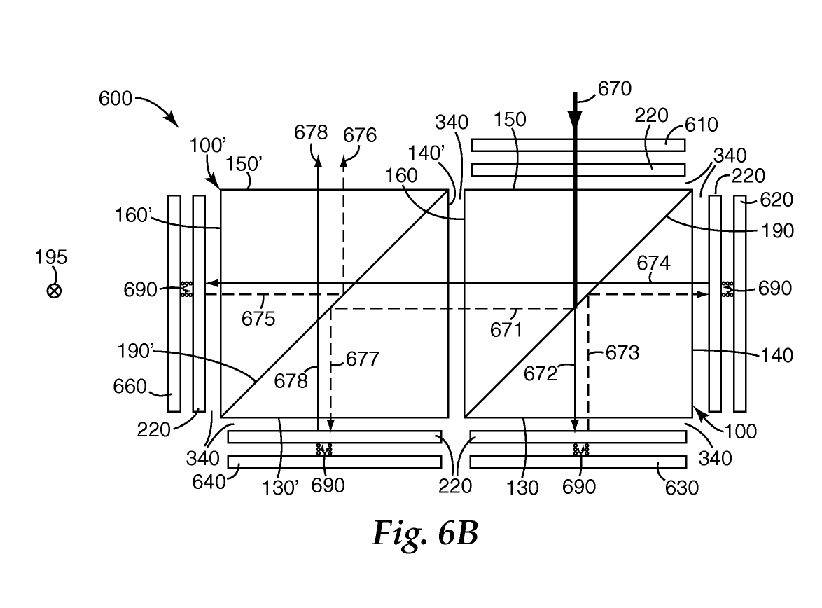

FIG. 6A is a top view of a light combiner 600 comprising PBS 100 and a second PBS 100′ according to one embodiment. PBS 100 comprises reflective polarizer 190 disposed between the diagonal faces of prisms 110,120. Prism 110 includes first and second prism faces 130, 140 having a 90° angle between them. Prism 120 includes third and fourth prism faces 150, 160 having a 90° angle between them. Second PBS 100′ comprises reflective polarizer 190′ disposed between the diagonal faces of prisms 110′, 120′. Prism 110′ includes fifth and sixth prism faces 140′, 130′ having a 90° angle between them. Prism 120′ includes seventh and eighth prism faces 160′, 150′ having a 90° angle between them. Reflective polarizers 190, 190′ can be Cartesian reflective polarizers aligned to the first polarization direction 195 (in this view, perpendicular to the page). Reflective polarizers 190, 190′ can be non-Cartesian polarizers, but Cartesian reflective polarizers are preferred. Second PBS 100′ is disposed adjacent to PBS 100 so that fourth prism face 160 is facing fifth prism face 140′. Fourth prism face 160 and fifth prism face 140′ can be separated by a gap, or adhered to each other using an optical adhesive. An optical adhesive, if used, should satisfy the refractive index relationship provided elsewhere to enable TIR at the prism faces.

Light combiner 600 includes quarter-wave retarders 220 disposed facing the first, second, third, sixth and seventh prism faces 130, 140, 150, 130′, 160′. Quarter-wave retarders 220 are aligned at a 45° angle to the first polarization direction 195, as described elsewhere. An optically transmissive material 340 is disposed between each quarter-wave retarder 220 and their respective prism faces. Optically transmissive material 340 can be any material that has an index of refraction lower than the index of refraction of prisms 110, 120, 110′, 120′. In one aspect, optically transmissive material 340 can be air. In another aspect, optically transmissive material 340 can be an optical adhesive which bonds quarter-wave retarders 220 to their respective prism faces.

Light combiner 600 includes a first, second, third, fourth and fifth reflector 610, 620, 630, 640, 660 disposed facing quarter-wave retarders 220 as shown. In one embodiment, reflectors 610, 620, 630, 640, 660 can be separated from the adjacent quarter-wave retarder 220 as shown in FIG. 6A. In another embodiment, reflectors 610, 620, 630, 640, 660 can be in direct contact with the adjacent quarter-wave retarder 220. In one embodiment, reflectors 610, 620, 630, 640, 650 can be adhered to the adjacent quarter-wave retarder 220 with an optical adhesive.

In one embodiment, light combiner 600 is a two color combiner. In this embodiment, two of reflectors 610, 620, 630, 640, 660 are first and second dichroic filter selected to transmit first and second color light respectively, and reflect other colors of light. The remaining three reflectors are mirrors. In one aspect, the first and second colors of light have minimum overlap in the spectral range, however there can be substantial overlap, if desired.

In one embodiment, light combiner 600 is a three color combiner. In this embodiment, three of reflectors 610, 620, 630, 640, 660 are first, second, and third dichroic filters selected to transmit first, second, and third color light, respectively, and reflect other colors of light. The remaining two reflectors are mirrors. In one aspect, the first, second, and third colors of light have minimum overlap in the spectral range, however there can be substantial overlap, if desired.

In one embodiment, light combiner 600 is a four color combiner. In this embodiment, four of reflectors 610, 620, 630, 640, 660 are first, second, third and a fourth dichroic filters selected to transmit first, second, third and a fourth color light respectively, and reflect other colors of light. The remaining reflector is a mirror. In one aspect, the first, second, third and fourth colors of light have minimum overlap in the spectral range, however there can be substantial overlap, if desired.

In one embodiment shown in FIG. 6A, light combiner 600 is a five color combiner. In this embodiment, reflectors 610, 620, 630, 640, 660 are first, second, third, fourth and a fifth dichroic filters selected to transmit first, second, third, fourth and a fifth color light respectively, and reflect other colors of light. In one aspect, the first, second, third, fourth and fifth colors of light have minimum overlap in the spectral range; however there can be substantial overlap, if desired. A method of using light combiner 600 of this embodiment includes the steps of directing a first light 670 having the first color toward first dichroic filter 610, directing a second light 692 having the second color toward second dichroic filter 620, directing a third light 694 having the third color toward third dichroic filter 630, directing a fourth light 696 having the fourth color toward fourth dichroic filter 640, directing a fifth light 698 having the fifth color toward fifth dichroic filter 660, and receiving combined light 680 from the seventh face of second PBS 100′. The optical path of the first light 670 is described with reference to FIG. 6B. For brevity, the optical paths of the second, third, fourth and fifth lights 692, 694, 696, 698 are not included, but can be determined by following the procedure described for FIG. 6B.

In one embodiment, each of the first, second, third, fourth and fifth lights 670, 692, 694, 696, 698 can be unpolarized light and the combined light 680 is unpolarized. In one embodiment, each of the first, second, third, fourth and fifth lights 670, 692, 694, 696, 698 can be red, green, blue, yellow and cyan unpolarized light, and the combined light 680 is unpolarized white light. According to one aspect, each of the first, second, third, fourth and fifth lights 670, 692, 694, 696, 698 comprises light from a light emitting diode (LED) source. Various light sources can be used such as lasers, laser diodes, organic LED's (OLED's), and non solid state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

Turning now to FIG. 6B, the optical path of first light 670 through light combiner 600 is described for the embodiment where first light 670 is unpolarized. In this embodiment, unpolarized light comprising light ray 676 having the second polarization direction, and light ray 678 having the first polarization direction, exits second PBS 100′ through eighth prism face 150′.

First light 670 is directed through first dichroic filter 610, quarter-wave retarder 220, and enters PBS 100 through third prism face 150. First light 670 intercepts reflective polarizer 190 and is split into light ray 672 having the first polarization direction and light ray 671 having the second polarization direction.

Light ray 671 having the second polarization direction, is reflected from reflective polarizer 190, exits PBS 100 through fourth prism face 160, and enters fifth prism face 140′ of second PBS 100′. Light ray 671 reflects from reflective polarizer 190′ as light ray 677 having the second polarization direction, exits second PBS 100′ through sixth prism face 130′, and changes to circularly polarized light 690 as it passes through quarter-wave retarder 220. Circularly polarized light 690 reflects from fourth dichroic filter 640, changing the direction of circular polarization, passes through quarter-wave retarder 220, and enters second PBS 100′ through sixth prism face 130′ as light ray 678 having the first polarization state. Light ray 678 having the first polarization direction passes through reflective polarizer 190′ and exits second PBS 100′ through eighth prism face 150′.

Light ray 672 having the first polarization direction exits PBS 100 through first prism face 130, and changes to circularly polarized light 690 as it passes through quarter-wave retarder 220. Circularly polarized light 390 reflects from third dichroic filter 630, changing the direction of circular polarization, and passes through quarter-wave retarder 220, entering PBS 100 through first prism face 130 as light ray 673 having the second polarization state. Light ray 673 reflects from reflective polarizer 190, exits PBS 100 through second prism face 140, and changes to circularly polarized light 690 as it passes through quarter-wave retarder 220. Circularly polarized light 690 reflects from second dichroic filter 620, changing the direction of circular polarization, and passes through quarter-wave retarder 220, entering PBS 100 through second prism face 140 as light ray 674 having the first polarization state. Light ray 674 having the first polarization direction, passes through reflective polarizer 190, exits PBS 100 through fourth prism face 160, and enters second PBS 100′ through fifth prism face 140′. Light ray 674 passes through reflective polarizer 190′, exits second PBS 100′ through seventh prism face 160′, and changes to circularly polarized light 690 as it passes through quarter-wave retarder 220. Circularly polarized light 690 reflects from fifth dichroic filter 660, changing the direction of circular polarization, passes through quarter-wave retarder 220, entering second PBS 100′ through seventh prism face 160′ as light ray 675 having the second polarization state. Light ray 675 reflects from reflective polarizer 190′ and exits second PBS 100′ through eighth prism face 150′ as light ray 676 having the second polarization direction.

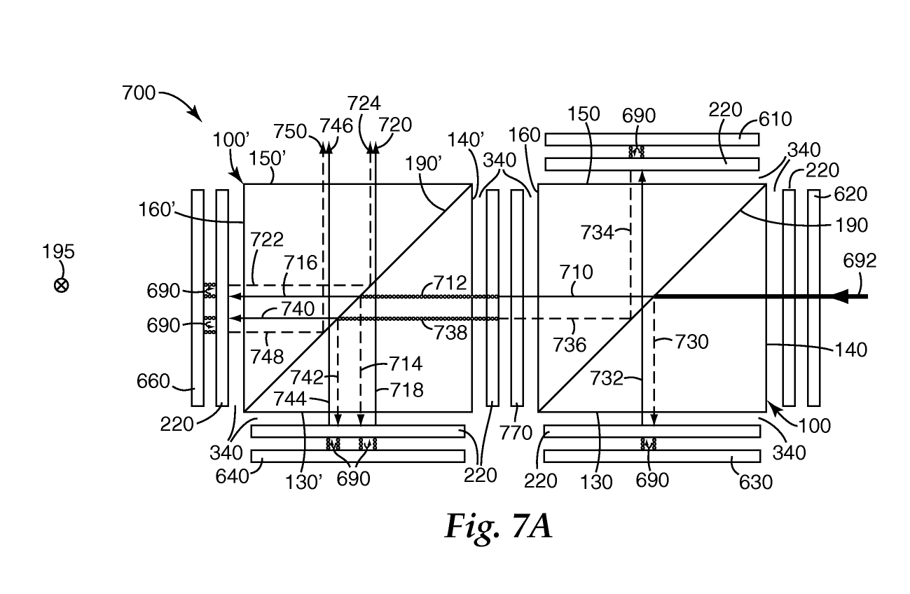

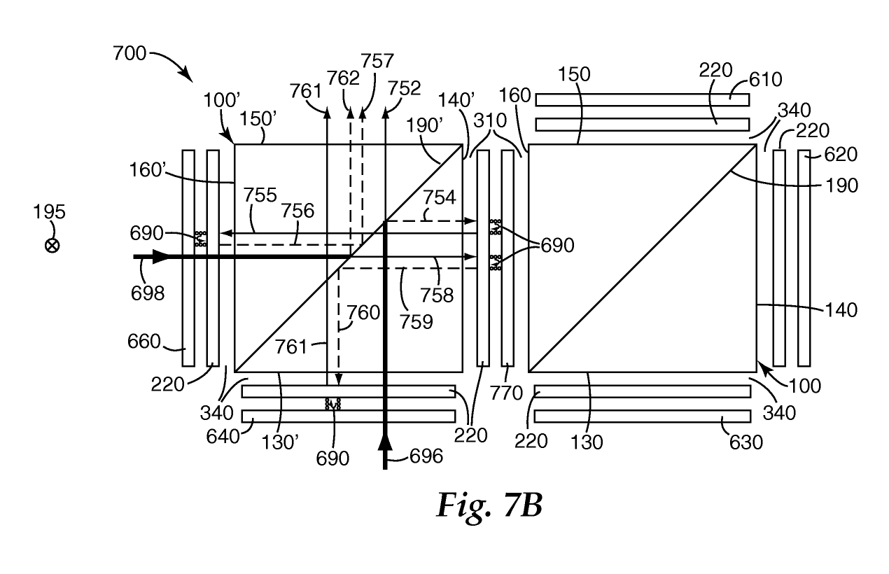

In one embodiment, the operation of light combiner 600 shown in FIGS. 6A and 6B can be improved by modifying the optical path of light rays entering second PBS 100′ through fourth and fifth reflectors 640 and 660. A sixth dichroic filter and an additional quarter-wave retarder can be positioned between PBS 100 and second PBS 100′ to modify the optical path. This embodiment is further described below, with reference to FIGS. 7A and 7B.

FIG. 7A is a top schematic view of the optical path of second light 692 through light combiner 700 according to one embodiment of the invention. Light combiner 700 comprises the light combiner 600 of FIGS. 6A and 6B with an additional sixth dichroic filter 770 and an additional quarter-wave retarder 220 disposed between fourth prism face 160 and fifth prism face 140′. Sixth dichroic filter 770 is disposed facing fourth prism face 160 and additional quarter-wave retarder 220 is disposed facing fifth prism face 140′. Optically transmissive material 340 is disposed between the sixth dichroic filter 770, additional quarter-wave retarder 220, and the fourth and fifth prism faces 160, 140′, respectively. Sixth dichroic filter 770 is selected to reflect at least one of the fourth and fifth colors of light, and transmit other colors of light.

Second light 692 passes through second dichroic filter 620, quarter-wave retarder 220, enters PBS 100 through second prism face 140, intercepts reflective polarizer 190, and is split into light ray 710 having the first polarization direction and light ray 730 having the second polarization direction. Light ray 710 passes through reflective polarizer 190 and exits PBS 100 through fourth prism face 160.

Light ray 730 reflects from reflective polarizer 190, exits PBS 100 through first prism face 130, and changes to circularly polarized light 690 as it passes through quarter-wave retarder 220. Circularly polarized light 690 reflects from third dichroic filter 630, changing the direction of circular polarization, and passes through quarter-wave retarder 220, entering PBS 100 through first prism face 130 as light ray 732 having the first polarization state. Light ray 732 passes through reflective polarizer 190, exits PBS 100 through third prism face 150, and changes to circularly polarized light 690 as it passes through quarter wave retarder 220. Circularly polarized light 690 reflects from first dichroic filter 610, changing the direction of circular polarization, passes through quarter-wave retarder 220, entering PBS 100 through third prism face 150 as light ray 734 having the second polarization state. Light ray 734 reflects from reflective polarizer 190 and leaves PBS 100 through fourth prism face 160 as light ray 736 having the second polarization direction.

It is to be understood that first and third lights 670 and 694 (shown in FIG. 6A) have optical paths through PBS 100 of FIG. 7A that are readily traced using the same method and with the same result as described for second light 692, but are omitted here for brevity. First and third lights 670 and 694 also leave PBS 100 through fourth prism face 160 in both first and second polarization directions.

After leaving PBS 100 through fourth prism face 160, both light rays 710 and 736 pass through sixth dichroic filter 770 and change to circularly polarized light rays 712 and 738 as they pass through quarter-wave retarder 220. Circularly polarized light rays 712 and 738 intercept reflective polarizer 190′ and are split into light rays 716 and 740 having the first polarization direction, and light rays 714 and 742 having the second polarization direction.

Light rays 716 and 740 exit second PBS 100′ through seventh prism face 160′ and change to circularly polarized light 690 as they pass through quarter-wave retarder 220. Circularly polarized light 690 reflects from fifth dichroic filter 660, changing the direction of circular polarization, passes through quarter-wave retarder 220, and enters second PBS 100′ through seventh prism face 160′ as light rays 722 and 748 having the second polarization state. Light rays 722 and 748 reflect from reflective polarizer 190′ and exit second PBS 100′ through eighth prism face 150′ as light rays 724 and 750, both having the second polarization state.

Light rays 714 and 742 are reflected from reflective polarizer 190′, exit second PBS 100′ through sixth prism face 130′, and change to circularly polarized light 690 as they pass through quarter-wave retarder 220. Circularly polarized light 690 reflects from fourth dichroic filter 640, changing the direction of circular polarization, passes through quarter-wave retarder 220, and enter second PBS 100′ through sixth prism face 130′ as light rays 718 and 744 having the first polarization state. Light rays 718 and 744 reflect pass through reflective polarizer 190′ and exit second PBS 100′ through eighth prism face 150′ as light rays 720 and 746, both having the first polarization state.

FIG. 7B shows the optical path of fifth and sixth light rays 696 and 698 through the light combiner 700 shown in FIG. 7A. Fifth and sixth light rays 696 and 698 enter second PBS 100′ and are prevented from entering PBS 100 by reflection from the sixth dichroic filter 770. A small amount of light is lost when light passes through or reflects from the reflective polarizers 190 and 190′. Sixth dichroic filter 770 can reduce these losses for fifth and sixth light rays 696 and 698 by preventing them from entering PBS 100, thereby improving the operation of light combiner 700.

Fourth light 696 passes through fourth dichroic filter 640, quarter-wave retarder 220, enters second PBS 100′ through sixth prism face 130′, intercepts reflective polarizer 190′ and is split into light ray 752 having the first polarization direction and light ray 754 having the second polarization direction. Light ray 752 having the first polarization passes through reflective polarizer 190′ and exits second PBS 100′ through eighth prism face 150′.

Light ray 754 reflects from reflective polarizer 190′, exits second PBS 100′ through fifth prism face 140′, and changes to circularly polarized light 690 as it passes through quarter-wave retarder 220. Circularly polarized light 690 reflects from sixth dichroic filter 770, changing the direction of circular polarization, passes through quarter-wave retarder 220 and enters second PBS 100′ through fifth prism face 140′ as light ray 755 having the first polarization state. Light ray 755 passes through reflective polarizer 190′, exits second PBS 100′ through seventh prism face 160′, and changes to circularly polarized light 690 as it passes through quarter-wave retarder 220. Circularly polarized light 690 reflects from fifth dichroic filter 660, changing the direction of circular polarization, passes through quarter-wave retarder 220 and enters second PBS 100′ through seventh prism face 160′ as light ray 756 having the second polarization state. Light ray 756 reflects from reflective polarizer 190′ and exits second PBS 100′ through eighth prism face 150′ as light ray 757 having the second polarization state.

Fifth light 698 passes through fifth dichroic filter 660, quarter-wave retarder 220, enters second PBS 100′ through seventh prism face 160′, intercepts reflective polarizer 190′ and is split into light ray 758 having the first polarization direction and light ray 762 having the second polarization direction. Light ray 762 having the second polarization direction reflects from reflective polarizer 190′ and exits second PBS 100′ through eighth prism face 150′.

Light ray 758 passes through reflective polarizer 190′, exits second PBS 100′ through fifth prism face 140′, and changes to circularly polarized light 690 as it passes through quarter-wave retarder 220. Circularly polarized light 690 reflects from sixth dichroic filter 770, changing the direction of circular polarization, passes through quarter-wave retarder 220 and enters second PBS 100′ through fifth prism face 140′ as light ray 759 having the second polarization state. Light ray 759 reflects from reflective polarizer 190′ as light ray 760, exits second PBS 100′ through sixth prism face 130′, and changes to circularly polarized light 690 as it passes through quarter-wave retarder 220. Circularly polarized light 690 reflects from fourth dichroic filter 640, changing the direction of circular polarization, passes through quarter-wave retarder 220 and enters second PBS 100′ through sixth prism face 130′ as light ray 761 having the first polarization state. Light ray 761 passes through reflective polarizer 190′ and exits second PBS 100′ through eighth prism face 150′ as light ray 761 having the first polarization state.

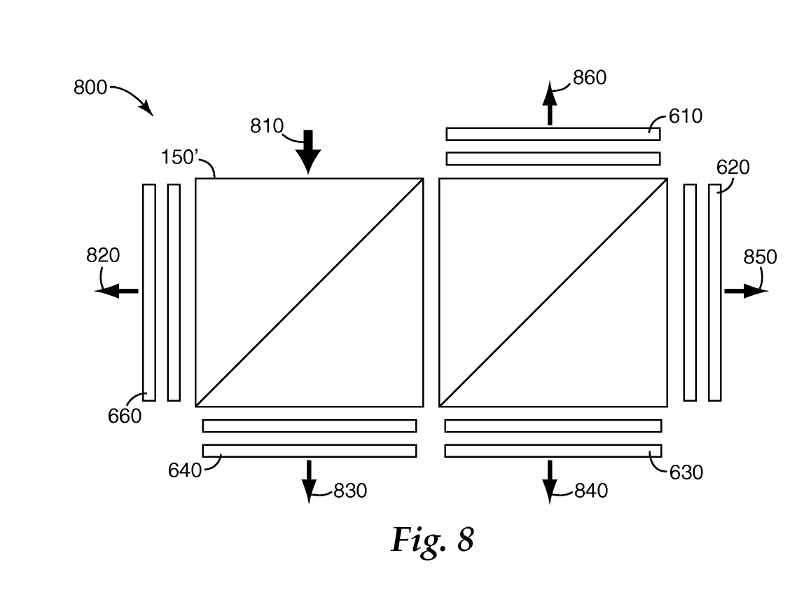

FIG. 8 is a top view schematic representation of a light splitter 800 according to one aspect of the invention. In one embodiment, light splitter 800 can use the same components as light combiner 600 shown in FIGS. 6A and 6B. In one embodiment, light splitter 800 can use the same components as light combiner 600 shown in FIGS. 7A and 7B. Light splitter 800 functions in reverse of light combiner 600, i.e. polychromatic combined light 810 is directed toward eighth prism face 150′, and split into first, second, third, fourth and fifth received light 820, 830, 840, 850, 860 having first, second, third, fourth and fifth color. In FIG. 8, light splitter 800 comprises the components of light combiner 600 described with reference to FIGS. 6A and 6B

In one embodiment, light splitter 800 is a two color splitter. In this embodiment, two of the reflectors 610, 620, 630, 640, 660 are first and second dichroic filters selected to transmit first and second color light respectively, and reflect other colors of light. The remaining three reflectors are mirrors. In one aspect, first and second color lights have minimum overlap in the spectral range, however there can be substantial overlap, if desired.

In one embodiment, light splitter 800 is a three color splitter. In this embodiment, three of the reflectors 610, 620, 630, 640, 660 are first, second and third dichroic filters selected to transmit first, second, and a third color lights respectively, and reflect other colors of light. The remaining two reflectors are mirrors. In one aspect, the first, second and third colors of light have minimum overlap in the spectral range, however there can be substantial overlap, if desired.

In one embodiment, light splitter 800 is a four color splitter. In this embodiment, four of the reflectors 610, 620, 630, 640, 660 are first, second, third and fourth dichroic filters selected to transmit first, second, third and fourth color lights respectively, and reflect other colors of light. The remaining reflector is a mirror. In one aspect, the first, second, third and fourth colors of light have minimum overlap in the spectral range, however there can be substantial overlap, if desired.

In one embodiment, light splitter 800 is a five color splitter. In this embodiment, reflectors 610, 620, 630, 640, 660 are first, second, third, fourth and fifth dichroic filters selected to transmit first, second, third, fourth and fifth color lights respectively, and reflect other colors of light. In one aspect, the first, second, third and fourth colors of light have minimum overlap in the spectral range, however there can be substantial overlap, if desired. A method of using light splitter 800 of this embodiment includes the steps of directing a combined light 810 toward eighth prism face 150′ of second PBS 100′, and receiving a first light 860 having the first color from first dichroic filter 610, receiving a second light 850 having the second color from second dichroic filter 620, receiving a third light 840 having the third color from third dichroic filter 630, receiving a fourth light 830 having the fourth color from fourth dichroic filter 640, and receiving a fifth light 820 having the fifth color from fifth dichroic filter 660. The optical path of each of the combined, first, second, third, fourth and fifth received lights 860, 850, 840, 830, 820 follow the description provided referring to FIG. 6B, however, the direction of all of the light rays is reversed.

In one embodiment, combined light 810 can be unpolarized light, and each of the first, second, third, fourth and fifth received lights 860, 850, 840, 830, 820 are unpolarized lights. In one embodiment, combined light 810 can be unpolarized white light, and each of the first, second, third, fourth and fifth received lights 860, 850, 840, 830, 820 are red, green, blue, yellow and cyan unpolarized lights. According to one aspect, combined light 810 comprises light from a light emitting diode (LED) source. Various light sources can be used such as lasers, laser diodes, organic LED's (OLED's), and non solid state light sources such as ultra high pressure (UHP), halogen or xenon lamps with appropriate collectors or reflectors. An LED light source can have advantages over other light sources, including economy of operation, long lifetime, robustness, efficient light generation and improved spectral output.

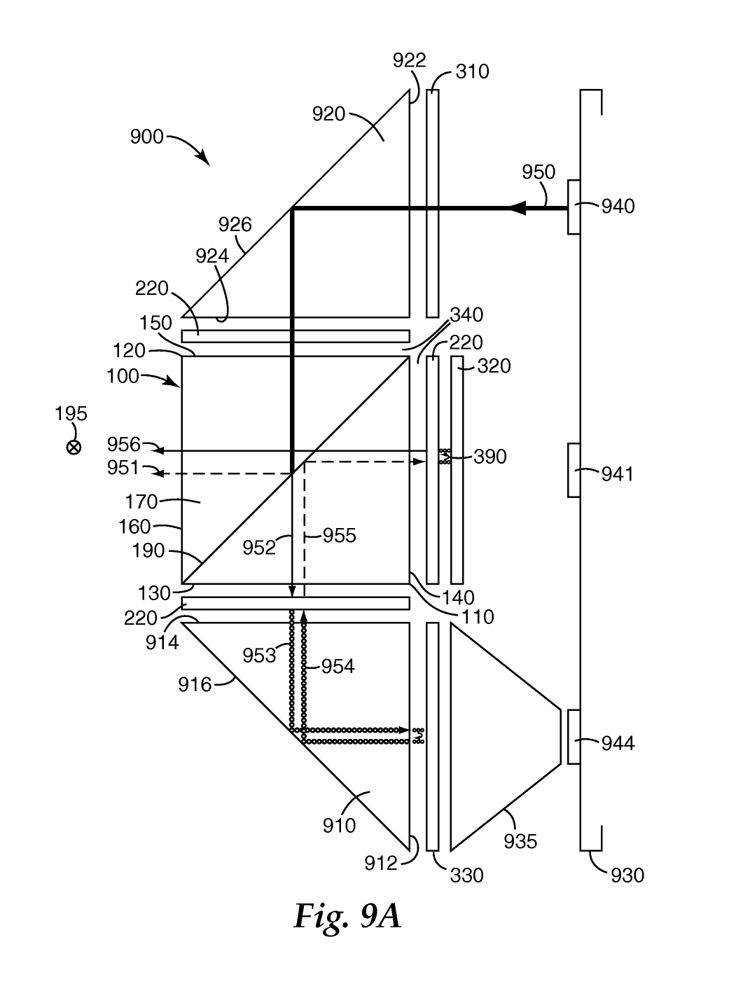

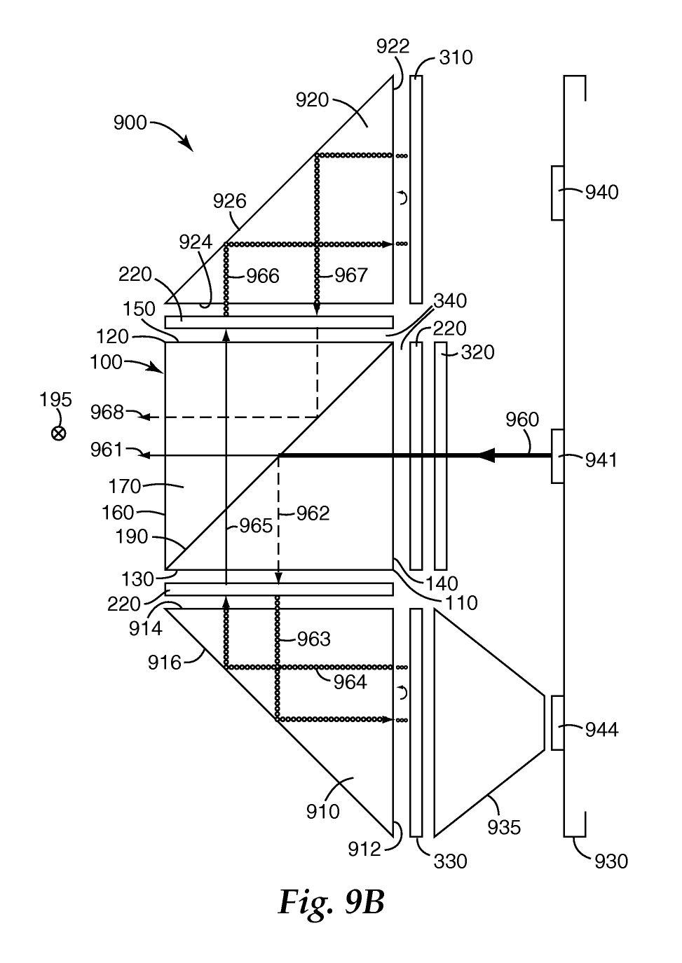

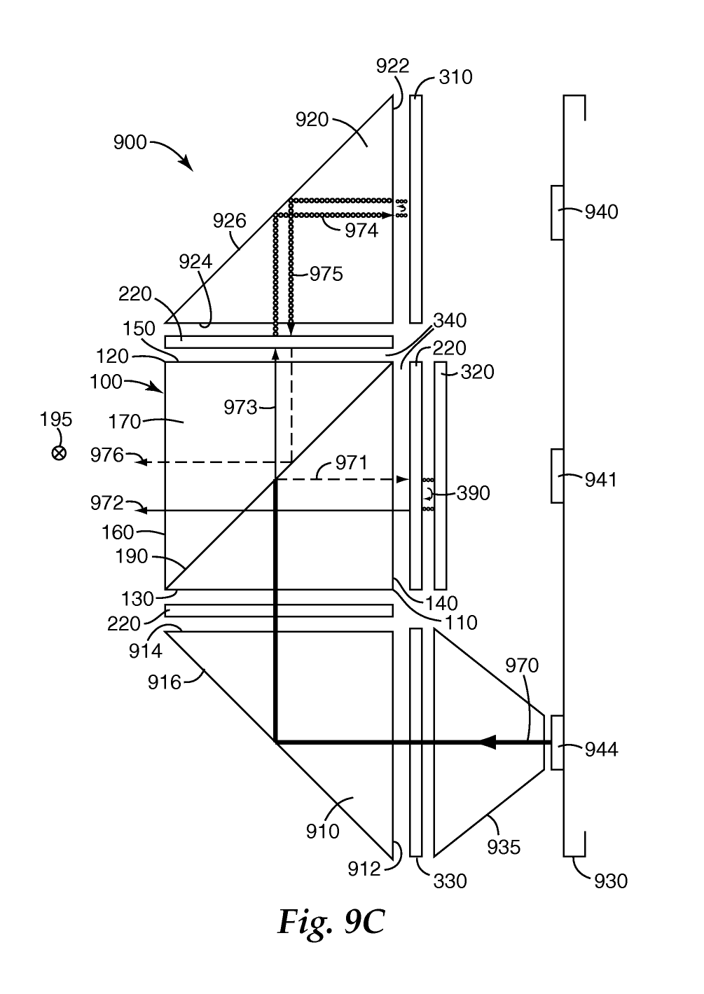

FIGS. 9A-9C are top views of a light combiner according to another aspect of the description. In FIGS. 9A-9C, paths of first through third light rays 950, 960, 970 are described through unfolded light combiner 900. Unfolded light combiner 900 can be one embodiment of light combiner 300 described with reference to FIGS. 3A-3D. In this embodiment, the first through third light sources 940, 942, 944 are disposed on the same plane 930. In one embodiment, plane 930 can be a heat exchanger common to the three light sources. Unfolded light combiner 900 includes third prism 910 and fourth prism 920 disposed facing first prism face 130 and third prism face 150, respectively, of PBS 100, described elsewhere. Third prism 910 and fourth prism 920 are each a “turning prism”. First and third light 950, 970 emanating from first and third light sources 940, 944 on plane 930 are turned by third and fourth prisms 910, 920 to enter PBS 100 in a direction perpendicular to first and second prism faces 120, 130, respectively.

Unfolded light combiner 900 includes quarter-wave retarders 220 disposed facing the first, second and third prism faces 130, 140, 150. Quarter-wave retarders 220 are aligned at a 45° angle to the first polarization direction 195. An optically transmissive material 340 is disposed between each quarter-wave retarder 220 and their respective prism faces. The optically transmissive material 340 can be any material that has an index of refraction lower than the index of refraction of prisms 110, 120. In one embodiment, the optically transmissive material 340 is air. In another embodiment, the optically transmissive material 340 is an optical adhesive which bonds quarter-wave retarders 220 to their respective prism faces.

Unfolded light combiner 900 includes third and fourth prisms 910, 920. Third prism 910 includes fifth and sixth prism faces 912, 914 and diagonal prism face 916 between them. Fifth and sixth prism faces 912, 914 are “turning prism faces”. Fifth prism face 912 is positioned to receive light from third light source 944 and direct light to first prism face 130. Fourth prism 920 includes seventh and eight prism faces 922, 924 and diagonal prism face 926 between them. Seventh and eighth prism faces 922, 924 also are “turning prism faces”. Seventh prism face 922 is positioned to receive light from first light source 940 and direct light to third prism face 150.

Fifth, sixth, seventh and eighth prism faces 912, 914, 922, 924, and diagonal prism faces 916, 926 can be polished for preservation of TIR, as described elsewhere. Diagonal prism faces 916, 926 of third and fourth prisms 910, 920 can also include a metal coating; a dielectric coating; an organic or inorganic interference stack; or a combination to enhance reflection.

Unfolded light combiner 900 further includes a first, second and third reflector 310, 320, 330 disposed to receive light from first, second and third light sources 940, 942, 944. In one embodiment shown in FIGS. 9A-9C, first reflector 310 and the associated retarder 220 are disposed facing seventh and eighth prism faces 922, 924, respectively, and are also facing third prism face 150 of PBS 100. In one embodiment, third reflector 330 and the associated retarder 220 are disposed facing fifth and sixth prism faces 912, 914, respectively, and are also facing first prism face 130 of PBS 100. In another embodiment (not shown), first reflector 310 and associated retarder 220 are positioned facing one another in a manner similar to the positioning of second reflector 320 and the associated retarder 220 (e.g. adjacent each other). In this case first reflector 310 and retarder 220 can either be placed adjacent to prism face 922, or adjacent to prism face 150. In principle, unfolded light combiner 900 can function regardless of the separation between reflectors and associated retarders, provided the orientation of each relative to the path of the light rays is unchanged, i.e. each is substantially perpendicular to the path of the light ray. However, depending on the nature of the reflection from diagonal prism faces 926 and 916, there may be more or less polarization mixing introduced by the reflection from those faces. This polarization mixing may result in lost light efficiency, and can be minimized by placing the reflectors 310 and 330 adjacent to prism faces 120 and 130.

Each of the reflectors 310, 320, 330 can be separate from the associated quarter-wave retarder 220 as shown in FIG. 9A-9C. Further, each of the reflectors 310, 320, 330 can be in direct contact with the adjacent quarter-wave retarder 220. Alternatively, each of the reflectors 310, 320, 330 can be adhered to the adjacent quarter-wave retarder 220 with an optical adhesive. The optical adhesive can be a curable adhesive. The optical adhesive can also be a pressure-sensitive adhesive.

Unfolded light combiner 900 can be a two color combiner. In this embodiment, two of the reflectors 310, 320, 330 are a first and a second dichroic filter selected to transmit a first and a second color light respectively, and reflect other colors of light. The third reflector is a mirror. By mirror is meant a specular reflector selected to reflect substantially all colors of light. The first and second color light can have minimum overlap in the spectral range; however there can be substantial overlap if desired.

In one embodiment shown in FIGS. 9A-9C, unfolded light combiner 900 is a three color combiner. In this embodiment, reflectors 310, 320, 330 are first, second and a third dichroic filter selected to transmit the first, second, and a third color light respectively, and reflect other colors of light. In one aspect, the first, second and third color light have minimum overlap in the spectral range, however there can be substantial overlap, if desired. A method of using unfolded light combiner 900 of this embodiment includes directing a first light 950 having the first color toward first dichroic filter 310, directing a second light 960 having the second color toward second dichroic filter 320, directing a third light 970 having the third color toward third dichroic filter 330, and receiving combined light from the fourth face 160 of PBS 100. The path of each of the first, second and third light 950, 960, 970 are further described with reference to FIGS. 9A-9C.

In one embodiment, each of the first, second and third light 950, 960, 970 can be unpolarized light and the combined light is unpolarized. In a further embodiment, each of the first, second and third lights 950, 960, 970 can be red, green and blue unpolarized light, and the combined light can be unpolarized white light. Each of the first, second, and third lights 950, 960, 970 can comprise light as described elsewhere with reference to FIGS. 3A-3D.

In one aspect, unfolded light combiner 900 can include an optional light tunnel 935 disposed between each of the first, second and third light source 940, 942, 944 and the respective fifth, second and seventh prism faces 912, 140, 922. A single optional light tunnel 935 is shown in FIGS. 9A-9C to indicate placement relative to third light source 944; however, it is to be understood that optional light tunnel 935 can be placed adjacent to any combination of first, second and third light source 940, 942, 944 and the respective prism faces 922, 140, 912. The light tunnels 935 can be useful to partially collimate light originating from the light source, and decrease the angle that the light enters PBS 100. Light tunnels 935 are an optional component for the unfolded color combiner 900, and can also be optional components for any of the color combiners and splitters described herein. The light tunnels could have straight or curved sides, or they could be replaced by a lens system. Different approaches may be preferred depending on specific details of each application, and those with skill in the art will face no difficulty in selecting the optimal approach for a specific application.

Turning now to FIG. 9A, the optical path of first light 950 through unfolded light combiner 900 is described for the embodiment where first light 950 is unpolarized. In this embodiment, unpolarized light comprising light ray 951 having the second polarization direction, and light ray 956 having the first polarization direction, exit PBS 100 through fourth prism face 160.

First light 950 is directed through first dichroic filter 310, enters fourth prism 920 through seventh prism face 922, reflects from diagonal 926, exits fourth prism 920 through eighth prism face 924, passes through quarter-wave retarder 220, and enters PBS 100 through third prism face 150. First light 950 intercepts reflective polarizer 190 and is split into light ray 952 having the first polarization direction and light ray 951 having the second polarization direction. Light ray 951 having the second polarization direction is reflected from reflective polarizer 190 and exits PBS 100 through fourth prism face 160.

Light ray 952 having the first polarization direction passes through reflective polarizer 190, exits PBS 100 through first prism face 130, and changes to circularly polarized light 953 as it passes through quarter-wave retarder 220. Circularly polarized light 953 enters third prism 910 through sixth prism face 914, reflects from diagonal 916 changing direction of circular polarization, exits third prism 910 through fifth prism face 912, and reflects from third dichroic filter 330, again changing the direction of circular polarization and becoming circularly polarized light 954. Circularly polarized light 954 enters third prism 910 though fifth prism face 912, reflects from diagonal 916 changing the direction of circular polarization, exits third prism 910 through sixth prism face 914 and becomes light ray 955 having the second polarization state as it passes through quarter-wave retarder 220. Light ray 955 having the second polarization state enters PBS 100 through first prism face 130, reflects from reflective polarizer 190, exits PBS 100 through second prism face 140, changes to circularly polarized light 390 as it passes through quarter-wave retarder 220, reflects from second dichroic filter 320, changing the direction of circular polarization, and becomes first light 956 having the first polarization direction as it passes through quarter-wave retarder 220. First light 956 having the first polarization direction enters PBS 100 through second prism face 140 passes through reflective polarizer 190, and exits PBS 100 through fourth prism face 160 as first light 956 having the first polarization direction.

Turning now to FIG. 9B, the optical path of second light 960 through unfolded light combiner 900 is described for the embodiment where second light 960 is unpolarized. In this embodiment, unpolarized light comprising light ray 968 having the second polarization direction, and light ray 961 having the first polarization direction, exit PBS 100 through fourth prism face 160.

Second light 960 is directed through second dichroic filter 320, quarter-wave retarder 220, and enters PBS 100 through second prism face 140. Second light 960 intercepts reflective polarizer 190 and is split into light ray 961 having the first polarization direction and light ray 962 having the second polarization direction. Light ray 961 having the first polarization direction passes through reflective polarizer 190 and exits PBS 100 through fourth prism face 160.

Light ray 962 having the second polarization direction, is reflected from reflective polarizer 190, exits the first prism face 130 of PBS 100, and changes to circularly polarized light 963 as it passes through quarter-wave retarder 220. Circularly polarized light 963 enters third prism 910 through sixth prism face 914, reflects from diagonal 916 changing the direction of circular polarization, exits third prism 910 through fifth prism face 912, reflects from third dichroic filter 330 again changing the direction of circular polarization, and enters third prism 910 through fifth prism face 912, as circularly polarized light 964. Circularly polarized light 964 reflects from diagonal 916 changing direction of circular polarization, exits third prism 910 through sixth prism face 914 and changes to second light 965 having the first polarization direction as it passes through retarder 220. Second light 965 having the first polarization direction enters PBS 100 through first prism face 130, passes unchanged through reflective polarizer 190, exits PBS 100 through third prism face 150, changes to circularly polarized light 966 as it passes through quarter-wave retarder 220, and enters fourth prism 920 through eighth prism face 924. Circularly polarized light 966 reflects from diagonal 992, changes direction of circular polarization, exits fourth prism 920 through seventh prism face 922, reflects from first dichroic filter 310 changing the direction of circular polarization and enters fourth prism 920 through seventh prism face 922 as circularly polarized light 967. Circularly polarized light 967 reflects from diagonal 926, changes direction of circular polarization, exits fourth prism 920 through eighth prism face 924, changes to second light 968 having the second polarization direction as it passes through retarder 220, enters PBS 100 through third prism face 150, reflects from reflective polarizer 190, and exits PBS 100 through fourth prism face 160 as second light 968 having the second polarization direction.

Turning now to FIG. 9C, the optical path of third light 970 through unfolded light combiner 900 is described for the embodiment where third light 970 is unpolarized. In this embodiment, unpolarized light comprising light ray 976 having the second polarization direction, and light ray 972 having the first polarization direction, exits PBS 100 through fourth prism face 160.

Third light 970 is directed through third dichroic filter 330, enters third prism 910 through fifth prism face 912, reflects from diagonal 916, exits third prism 910 through sixth prism face 914, passes through quarter-wave retarder 220, and enters PBS 100 through first prism face 130. Third light 970 intercepts reflective polarizer 190 and is split into light ray 973 having the first polarization direction and light ray 971 having the second polarization direction. Light ray 973 having the first polarization direction passes through reflective polarizer 190, exits the third prism face 150, changes to circularly polarized light 974 as it passes through quarter-wave retarder 220 and enters fourth prism 920 through eighth prism face 924. Circularly polarized light 974 reflects from diagonal 926 changing the direction of circular polarization, exits fourth prism 920 through seventh prism face 922, reflects from first dichroic filter 310 changing the direction of circular polarization, enters fourth prism 920 through seventh prism face 922, and becomes circularly polarized light 975 as it reflects from diagonal 926 again changing the direction of circular polarization. Circularly polarized light 975 exits fourth prism 920 through eighth prism face 923, changes to third light ray 976 having the second polarization direction as it passes through quarter-wave retarder 220, enters PBS 100 through third prism face 150, reflects from reflective polarizer 190, and exits PBS 100 through fourth prism face 160 as third light 976 having the second polarization direction.

Light ray 971 having the second polarization direction, reflects from reflective polarizer 190, exits PBS 100 through the second prism face 140 and changes to circularly polarized light 390 as it passes through quarter-wave retarder 220. Circularly polarized light 390 reflects from second dichroic filter 320, changing the direction of circular polarization, passes again through quarter-wave retarder 220 and enters PBS 100 through second prism face 140 as light ray 972 having the first polarization direction. Light ray 972 having the first polarization direction, passes through reflective polarizer 190 and exits PBS 100 through fourth prism face 160.

In one aspect, any of the 2, 3, 4, and 5 color light combiners and splitters described herein can be unfolded in a manner similar to that described with reference to FIGS. 3A-3D and FIGS. 9A-9C. Prisms can be added to direct the light from a common plane to one of the input faces of the PBS (combiners), or from the PBS to a common plane (splitters). The unfolded light combiners can benefit from positioning of the input light sources along a common plane, for example, so that a common heat exchanger can be used to remove heat generated by the light sources. The unfolded light splitters can likewise benefit from having the split colors of light emitted from the same plane.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A light combiner, comprising:
a first polarizing beam splitter, comprising:
first and second prisms;
first, second, third, and fourth prism faces;
a reflective polarizer disposed between the first and second prisms;
a first dichroic filter that transmits a first wavelength spectrum of light and reflects other wavelengths of light, disposed facing the first prism face;
a second dichroic filter that transmits a second wavelength spectrum of light and reflects other wavelengths of light, disposed facing the second prism face;
a reflector that reflects at least the first and second wavelength spectrums of light, disposed facing the third prism face; and
a retarder disposed between each of the reflector, first dichroic filter, and second dichroic filter, and their respective prism faces.

2. The light combiner of claim 1, wherein the retarder is a quarter-wave retarder aligned at 45 degrees to a first polarization direction.

3. The light combiner of claim 2, wherein the reflective polarizer is aligned to the first polarization direction.

4. The light combiner of claim 3, wherein the reflective polarizer is a Cartesian reflective polarizer.

5. The light combiner of claim 4, wherein the Cartesian reflective polarizer is a polymeric multilayer optical film.

6. The light combiner of claim 1, wherein the reflector is a mirror.

7. The light combiner of claim 1, wherein the reflector is a third dichroic filter that transmits a third wavelength spectrum of light and reflects other wavelengths of light.

8. The light combiner of claim 1, wherein the polarizing beam splitter further comprises end faces, and wherein the prism faces and end faces are polished.

9. The light combiner of claim 8, further comprising an optically transmissive material in contact with each of the polished faces, the index of refraction of each of the first and second prisms being greater than the index of refraction of the optically transmissive material so that total internal reflection can occur within the first and second prisms.

10. The light combiner of claim 9, wherein the optically transmissive material in contact with at least one of the polished faces is air.

11. The light combiner of claim 9, wherein the optically transmissive material in contact with at least one of the polished faces is an optical adhesive.

12. A method of combining light, comprising:
providing the light combiner of claim 1;
directing light of the first and second wavelength spectrums toward the first and second dichroic filters, respectively; and
receiving a combined light from the fourth prism face.

13. The method of claim 12, wherein the reflector is a third dichroic filter that transmits a third wavelength spectrum of light and reflects other wavelengths of light, further comprising: directing light of the third wavelength spectrum toward the third dichroic filter.

14. The method of claim 12, wherein the reflector is a mirror.

15-21. (canceled)

22. A light combiner, comprising:
a first polarizing beam splitter, comprising:
first and second prisms;
first, second, third, and fourth prism faces;
a first reflective polarizer disposed between the first and second prisms;
a second polarizing beam splitter disposed adjacent the fourth prism face, the second polarizing beam splitter comprising:
third and fourth prisms;
a fifth prism face adjacent the fourth prism face;
sixth, seventh and eighth prism faces;
a second reflective polarizer disposed between the third and fourth prisms;
first through fifth reflectors disposed facing the first, second, third, sixth and seventh prism faces, wherein:
the first reflector is a first dichroic filter that transmits a first wavelength spectrum of light and reflects other wavelengths of light;
the second reflector is a second dichroic filter that transmits a second wavelength spectrum of light and reflects other wavelengths of light;
the third, fourth and fifth reflectors each reflect at least the first and second wavelength spectrums of light; and
a retarder disposed between each of the reflectors, and their respective prism faces.

23. The light combiner of claim 22, wherein the retarder is a quarter-wave retarder aligned at 45 degrees to a first polarization direction.

24. The light combiner of claim 23, wherein at least one of the first and second reflective polarizers is aligned to the first polarization direction.

25. The light combiner of claim 24, wherein at least one of the first and second reflective polarizers is a Cartesian reflective polarizer.

26. The light combiner of claim 25, wherein the Cartesian reflective polarizer is a polymeric multilayer optical film.

27. The light combiner of claim 22, wherein at least one of the third, fourth or fifth reflectors is a mirror.

28. The light combiner of claim 22, wherein at least one of the third, fourth or fifth reflectors is a third dichroic filter that transmits a third wavelength spectrum of light and reflects other wavelengths of light.

29. The light combiner of claim 28, wherein at least one of the third, fourth or fifth reflectors is a fourth dichroic filter that transmits a fourth wavelength spectrum of light and reflects other wavelengths of light.

30. The light combiner of claim 29, wherein at least one of the third, fourth or fifth reflectors is a fifth dichroic filter that transmits a fifth wavelength spectrum of light and reflects other wavelengths of light.

31. The light combiner of claim 22, wherein each polarizing beam splitter further comprises end faces, and wherein all of the prism faces and end faces are polished.

32. The light combiner of claim 31, further comprising an optically transmissive material in contact with each of the polished faces, the index of refraction of each of the first, second, third, and fourth prisms being greater than the index of refraction of the optically transmissive material so that total internal reflection can occur within the first, second, third, and fourth prism.

33. The light combiner of claim 32, wherein the optically transmissive material in contact with at least one of the prism faces and end faces is air.

34. The light combiner of claim 32, wherein the optically transmissive material in contact with at least one of the prism faces and end faces is an optical adhesive.

35. The light combiner of claim 23, further comprising:
a sixth dichroic filter that reflects light entering from the sixth and seventh faces, disposed between the first and second polarizing beam splitters; and
an additional quarter-wave retarder aligned at 45° to the first polarization direction, disposed between the fourth prism face and the sixth dichroic filter.

36. The light combiner of claim 35, wherein the sixth dichroic filter transmits light entering from the first, second and third faces.

37. A method of combining light, comprising:
providing the light combiner of claim 22;
directing light of the first and second wavelength spectrum toward the light combiner through the first and second dichroic filters respectively; and
receiving a combined light from the eighth prism face.

38. The method of claim 37, wherein at least one of the reflectors is a third dichroic filter that transmits a third wavelength spectrum of light and reflects other wavelengths of light, further comprising:
directing light of the third wavelength spectrum toward the light combiner through the third dichroic filter.

39. The method of claim 38, wherein at least one of the reflectors is a fourth dichroic filter that transmits a fourth wavelength spectrum of light and reflects other wavelengths of light, further comprising:
directing light of the fourth wavelength spectrum toward the light combiner through the fourth dichroic filter.

40. The method of claim 39, wherein at least one of the reflectors is a fifth dichroic filter that transmits a fifth wavelength spectrum of light and reflects other wavelengths of light, further comprising:
directing light of the fifth wavelength spectrum toward the light combiner through the fourth dichroic filter.

41-49. (canceled)

50. The light combiner of claim 1, further comprising at least one turning prism having a diagonal face and a turning prism face, wherein the turning prism face is disposed facing at least one retarder.
